(19) United States
(12) Patent Application Publication
(10) Pub. No.: US 2025/0039973 A1
(43) Pub. Date: Jan. 30, 2025

(54) CONNECTION ESTABLISHMENT METHOD AND APPARATUS

(71) Applicant: SAMSUNG ELECTRONICS CO., LTD., Suwon-si (KR)

(72) Inventors: Zehong LIN, Guangzhou (CN); Yongli Li, Guangzhou (CN); Qin Zhou, Guangzhou (CN); Tianwei Hong, Guangzhou (CN); Fangran Ruan, Guangzhou (CN)

(73) Assignee: SAMSUNG ELECTRONICS CO., LTD., Suwon-si (KR)

(21) Appl. No.: 18/760,287

(22) Filed: Jul. 1, 2024

Related U.S. Application Data
(63) Continuation of application No. PCT/KR2024/095807, filed on May 17, 2024.

(30) Foreign Application Priority Data
Jul. 28, 2023 (CN) 202310940499.3

(51) Int. Cl. H04W 76/25; H04W 84/12

(52) U.S. Cl. CPC H04W 76/25; H04W 84/12

(57) ABSTRACT

A connection establishment method, applied to a first electronic device, includes: establishing a first wireless communication connection with at least one other electronic device identified based on a first search; determining at least one candidate electronic device from the at least one other electronic device based on the first wireless communication connection; displaying first identification information of the at least one candidate electronic device on an interface of the first electronic device; and establishing a second wireless communication connection with at least one target electronic device based on detecting a preset operation of a user and second identification information of the at least one target electronic device, wherein the at least one target electronic device includes one or more of the at least one candidate electronic device.

### CROSS-REFERENCE TO RELATED APPLICATIONS

This application is a by-pass continuation application of International Application No. PCT/KR2024/095807, filed on May 17, 2024, which is based on and claims priority to China Application No. 202310940499.3, filed on Jul. 28, 2023 with the China National Intellectual Property Administration, the disclosures of which are incorporated by reference herein in their entireties.

### BACKGROUND

### 1. Field

The disclosure relates to an electronic technology field and, more in particular, to a connection establishment method and apparatus.

### 2. Description of Related Art

Multiple electronic devices are increasingly becoming more interconnected, and conveniently establishing a Wireless Local Area Network (WLAN) direct connection (for example, WIFI peer-to-peer (P2P) connection) between electronic devices may enhance the user experience.

Currently, to realize the WLAN direct connection between electronic devices (for example, a device A and a device B), the user is first required to enable the WLAN direct connection communications of the device A and the device B; after the device A detects the device B, the user is required to select, on the device A, the device B as the object of the WLAN direct connection; and after the device B receives the request for the WLAN direct connection from the device A, the user is required to confirm acceptance of the request on the device B to establish the WLAN direct connection between the device A and the device B. In the above process, the user is required to operate the device A and the device B, and the operation steps are cumbersome and time-consuming, which reduces the user experience.

### SUMMARY

One or more embodiments provide a connection establishment method and apparatus that may establish a wireless communication connection between two electronic devices.

According to one or more embodiments, a connection establishment method, applied to a first electronic device, includes: establishing a first wireless communication connection with at least one other electronic device identified based on a first search; determining at least one candidate electronic device from the at least one other electronic device based on the first wireless communication connection; displaying first identification information of the at least one candidate electronic device on an interface of the first electronic device; and establishing a second wireless communication connection with at least one target electronic device based on detecting a preset operation of a user and second identification information of the at least one target electronic device, wherein the at least one target electronic device includes one or more of the at least one candidate electronic device.

The determining the at least one candidate electronic device from the at least one other electronic device based on the first wireless communication connection may include: requesting the at least one other electronic device to enable second wireless communications by the first wireless communication connection; receiving association information sent by the at least one other electronic device associated with the second wireless communications; and determining the at least one candidate electronic device based on the association information, wherein the second wireless communications correspond to the second wireless communication connection.

The association information may include second address information corresponding to the second wireless communications, and the determining the at least one candidate electronic device based on the association information may include: matching third address information of at least one third electronic device identified through the second wireless communications with the second address information; and determining at least one of the at least one third electronic device whose third address information matches the second address information as the at least one candidate electronic device.

The association information may include information indicating the second wireless communications have been enabled and second address information corresponding to the second wireless communications, and the determining the at least one candidate electronic device based on the association information may include determining at least one of the at least one other electronic device that has sent the association information as the at least one candidate electronic device.

The establishing the first wireless communication connection may further include automatically enabling second wireless communications of the first electronic device based on an event being detected, wherein the event includes at least one of: receiving a first user operation triggering an opening of an application, or receiving a second user operation triggering a display of a connection object setting interface for the second wireless communication connection, wherein the application supports transmitting content across devices, and wherein the second wireless communications correspond to the second wireless communication connection.

Based on the determining the at least one candidate electronic device, the method may further include disconnecting the first wireless communication connection from the at least one candidate electronic device.

The at least one other electronic device may send a low power Bluetooth broadcast signal in a vicinity of the first electronic device.

The first wireless communication connection may be a Bluetooth connection.

The second wireless communication connection may be a WLAN direct connection.

According to one or more embodiments, a connection establishment method, applied to a second electronic device, includes: sending a low power Bluetooth broadcast signal carrying first address information corresponding to first wireless communications; establishing a first wireless communication connection with a first electronic device corresponding to the first wireless communication connection; enabling second wireless communications of the second electronic device based on the first wireless communication connection; and establishing a second wireless communication connection with the first electronic device, wherein the second wireless communications correspond to the second wireless communication connection.

The enabling the second wireless communications may include automatically enabling the second wireless communications of the second electronic device based on a second wireless communications enable request received from the first electronic device by the first wireless communication connection.

Based on the enabling of the second wireless communications of the second electronic device, the connection establishment method may further include sending association information of the second electronic device associated with the second wireless communications to the first electronic device by the first wireless communication connection.

The association information may include at least one of: first information indicating that the second electronic device has enabled the second wireless communications or second address information of the second electronic device corresponding to the second wireless communications.

The first wireless communication connection may be a Bluetooth connection.

According to one or more embodiments, a connection establishment apparatus, applied to a first electronic device, includes: one or more processors; and a memory storing at least one instruction that, when executed by at least one of the one or more processors, causes the apparatus to: establish a first wireless communication connection with at least one other electronic device identified based on a search; determine at least one candidate electronic device from the at least one other electronic device based on the first wireless communication connection; display first identification information of the at least one candidate electronic device on an interface of the first electronic device; and establish a second wireless communication connection with at least one target electronic device based on a detected preset operation of a user and second identification information of the at least one target electronic device, wherein the at least one target electronic device includes one or more of the at least one candidate electronic device.

The apparatus may be configured to determine the at least one candidate electronic device by executing the at least one instruction to cause the apparatus to: request the at least one other electronic device to enable second wireless communications by the first wireless communication connection; receive association information sent by the at least one other electronic device by the second wireless communications; and determine the at least one candidate electronic device based on the association information, wherein the second wireless communications correspond to the second wireless communication connection.

The association information may include second address information corresponding to the second wireless communications, and the apparatus may be configured to determine the at least one candidate electronic device based on the association information by executing the at least one instruction to cause the apparatus to: match third address information of at least one third electronic device identified through the second wireless communications with the second address information; and determine at least one of the at least one third electronic device whose third address information matches the second address information as the at least one candidate electronic device.

The association information may include: information indicating the second wireless communications have been enabled; and second address information corresponding to the second wireless communications, and the apparatus may be configured to determine the at least one candidate electronic device based on the association information by executing the at least one instruction to cause the apparatus to determine at least one of the at least one other electronic device that has sent the association information as the at least one candidate electronic device.

The apparatus may be further configured to establish the first wireless communication connection by executing the at least one instruction to cause the apparatus to automatically enable second wireless communications of the first electronic device based on an event being detected, wherein the event includes at least one of: a first user operation triggering an opening of an application being received; or a second user operation triggering a display of a connection object setting interface for the second wireless communication connection being received, wherein the application is configured to transmit content across devices, and wherein the second wireless communications correspond to the second wireless communication connection.

The apparatus may be further configured to execute the at least one instruction to cause the apparatus to disconnect the first wireless communication connection from the at least one candidate electronic device based on the at least one candidate electronic device being determined.

### BRIEF DESCRIPTION OF THE DRAWINGS

The foregoing and other objects and features of exemplary embodiments of the present disclosure will become clearer by the following description in connection with the accompanying drawings illustrating the exemplary embodiments, wherein:

FIG. 1 illustrates a flowchart of a connection establishment method according to one or more embodiments;

FIG. 2 illustrates a flowchart of a connection establishment method according to one or more embodiments;

FIG. 3 illustrates an overall flowchart of a connection establishment method according to one or more embodiments;

FIG. 4 illustrates an example of a connection establishment method according to one or more embodiments;

FIG. 5 illustrates an example of a connection establishment method according to one or more embodiments;

FIG. 6 illustrates an architecture diagram of a connection establishment apparatus according to one or more embodiments;

FIG. 7 illustrates an architecture diagram of a connection establishment apparatus according to one or more embodiments.

### DETAILED DESCRIPTION

Reference will now be made in detail to embodiments of the present disclosure, examples of the embodiments being shown in the accompanying drawings, wherein the same labels always refer to the same components. The embodiments will be illustrated below by reference to the accompanying drawings for the purpose of explaining the present disclosure.

The embodiments described, and the configurations shown in the drawings, are only examples of embodiments of the present disclosure, and various modifications may be made without departing from the scope and spirit of the disclosure.

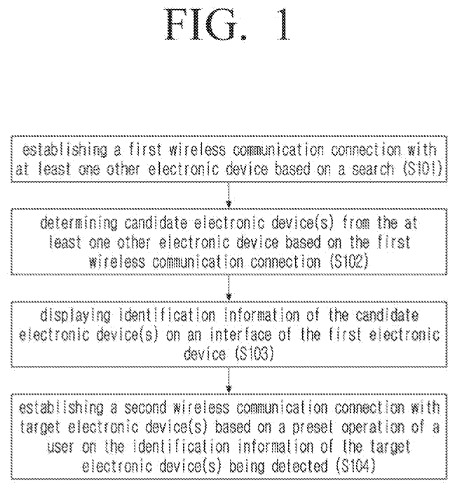

FIG. 1 illustrates a flowchart of a connection establishment method according to one or more embodiments. The connection establishment method is applied to a first electronic device.

The connection establishment method may be implemented by a computer program. For example, the connection establishment method may be performed by an application installed in the first electronic device, or by a program implemented in an operating system of the first electronic device.

As an example, the first electronic device may be an electronic device such as a mobile communication terminal (for example, a smartphone), a smart wearable device (for example, a smartwatch), a personal computer, a tablet computer, a game console, a digital multimedia player, and the like.

Referring to FIG. 1, in operation S101, a first wireless communication connection is established with at least one other electronic device based on a search.

As an example, the at least one other electronic device may be a nearby electronic device identified via a search by the first electronic device. As an example, the at least one other electronic device may be an electronic device in the vicinity of the first electronic device that sends a low power Bluetooth BLE broadcast signal, or may be an electronic device whose BLE broadcast signal is scanned by the first electronic device.

As an example, the at least one other electronic device may be a nearby electronic device identified via a search by the first electronic device that satisfies a preset condition. The preset condition may include, but is not limited to, at least one of: being trusted; being in the same Local Area Network (LAN) as the first electronic device; and being likely to be used by a user. For example, if an electronic device is logged into the same user account as the first electronic device, the electronic device may be considered as a trusted electronic device of the first electronic device. In addition, the first electronic device may also identify a trusted electronic device based on its preset list of trusted devices. For example, if it is determined by an UWB spatial location that a user is within an angular range and/or distance where an electronic device may be used in the vicinity of the electronic device, it is determined that the user may be likely to use the electronic device.

As an example, operation S101 may include: establishing the first wireless communication connection with the at least one other electronic device identified via the search based on a first event being detected.

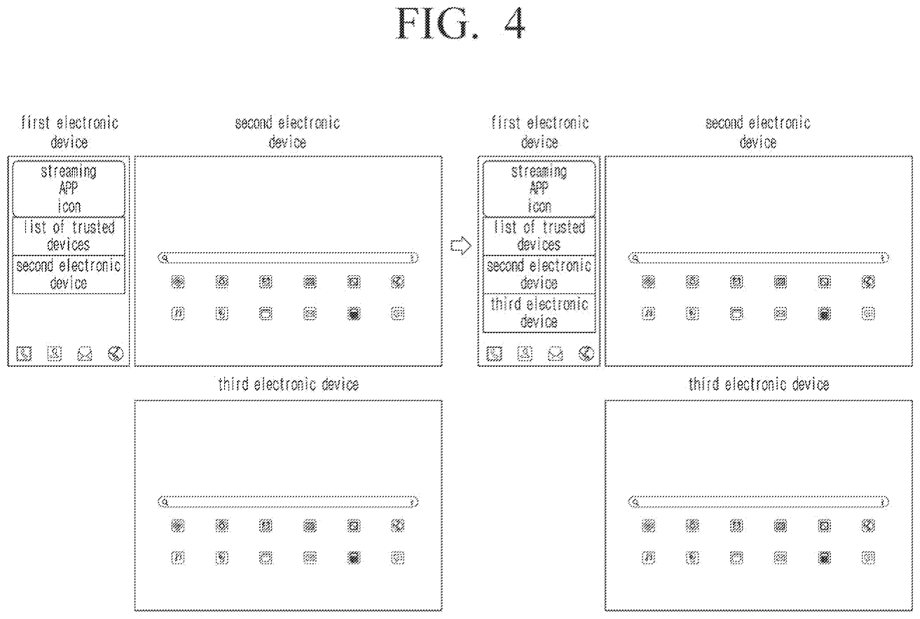

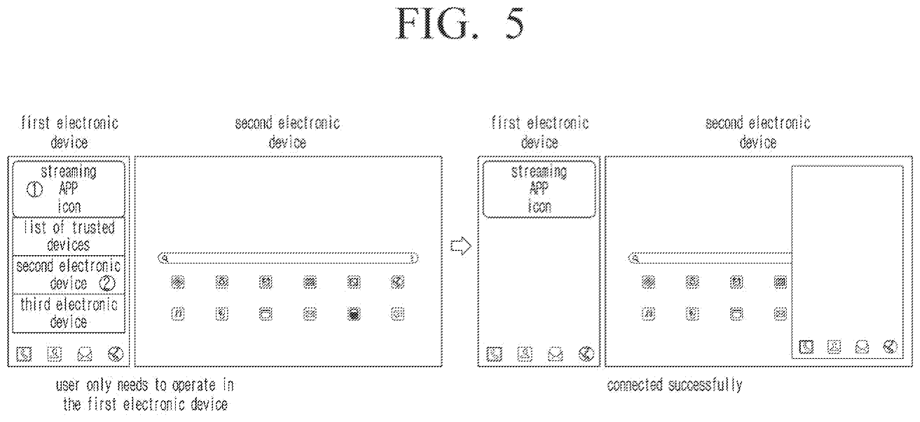

As an example, the first event may include, but is not limited to, at least one of: receiving a user operation triggering the opening of an application; receiving a user operation triggering the display of a connection object setting interface for the second wireless communication connection. As an example, the user operation triggering the display of the connection object setting interface for the second wireless communication connection may include, but is not limited to: clicking on a floating window (for example, a streaming floating window) for triggering a cross-device transmission; clicking on an icon of the application. As an example, the application described above may be an application for transmitting content across devices, for example, the application may be a streaming application. The connection object setting interface for the second wireless communication connection is an interface for the user to select a connection object for the second wireless communication connection, for example, as illustrated in FIGS. 4 and 5. With respect to the streaming application, it may include the following as an example. Based on the first electronic device receiving an invitation to make a video call, the user wishes to make the video call with another electronic device. The user may click on a floating window for streaming the video call to display a connection object setting interface, and based on the user selecting the second electronic device through the connection object setting interface, the first electronic device will establish a WIFI P2P connection with the second electronic device. The video call interface of the first electronic device may be streamed to the second electronic device, and a camera and an audio apparatus of the second electronic device may be used, so that the user may make the video call on the second electronic device.

It is to be understood that the first event may be flexibly set according to actual situations, and the present disclosure is not limited thereto.

As an example, operation S101 may include: establishing the first wireless communication connection with the at least one other electronic device identified based on a search and enabling a second wireless communications of the first electronic device based on a first event being detected.

The second wireless communications is a wireless communications corresponding to the second wireless communication connection. As an example, the second wireless communication connection may be a wireless local area network (WLAN) direct connection. It is to be understood that the second wireless communication connection may also be other types of wireless communication connections, and the present disclosure is not limited thereto.

As an example, the connection establishment method according to one or more embodiments may further include: prior to operation S101, searching for the at least one other electronic device.

As an example, at least one electronic device that sends a BLE broadcast signal may be determined based on the scanned BLE broadcast signal. As an example, the scanned BLE broadcast signal may carry identification information of the electronic device sending it and address information corresponding to the first wireless communications (hereinafter, also referred to as first address information), or the identification information and the first address information of the electronic device may be obtained from the received BLE broadcast signal. The first wireless communications is a wireless communications corresponding to the first wireless communication connection.

As an example, the first wireless communication connection may be a Bluetooth (BT) connection. As an example, the first address information may be a Bluetooth physical address (BT MAC address). It is to be understood that the first wireless communication connection may also be other types of wireless communication connections, and the present disclosure is not limited thereto.

As an example, the first wireless communication connection may be established with the at least one other electronic device by the first address information of the at least one other electronic device.

As an example, the identification information of the electronic device may be information used to characterize the electronic device, for example, may be a name of the electronic device.

As an example, the at least one other electronic device may be searched for based on a second event being detected. As an example, the second event may include, but is not limited to, at least one of an event triggering the display of an icon for the application. As an example, the event triggering the display of the icon of the application may be an event that may use the application. For example, the event that may use the application may include, but is not limited to: receiving a call invitation; initiating a call invitation; and entering a call scenario. For example, the call invitation may be a VoIP call invitation, and may further include a video call invitation, a voice call invitation. It is to be understood that the second event may be flexibly set according to actual situations, and the present disclosure is not limited thereto.

As an example, the at least one other electronic device may be periodically searched for.

In one or more embodiments, the at least one other electronic device in the vicinity sends a BLE broadcast signal at a determined frequency, and the first electronic device periodically searches for the nearby electronic device that sends the BLE broadcast signal in the background. The first electronic device displays an icon of a streaming application based on the first electronic device detecting an event triggering the display of the icon of the streaming application (for example, receiving an invitation to make a video call) occur; and, based on the user operation of clicking on the streaming application, establishes the first wireless communication connection with the at least one other electronic device identified based on the search.

In one or more embodiments, the at least one other electronic device in the vicinity sends a BLE broadcast signal at a determined frequency, and based on the first electronic device detecting that an event triggering the display of an icon of a streaming application (for example, receiving an invitation to make a video call) occurs, the first electronic device displays the icon of the streaming application and searches for the electronic device that sends the BLE broadcast signal in the vicinity; and based on the user operation of clicking on the streaming application, establishes the first wireless communication connection with the at least one other electronic device identified based on the search.

In operation S102, candidate electronic device(s) is/are determined from the at least one other electronic device based on the first wireless communication connection.

As a first example, operation S102 may include: requesting the at least one other electronic device to enable the second wireless communications by the first wireless communication connection; and determining the candidate electronic device(s) based on electronic device(s) among the at least one other electronic device that has/have enabled the second wireless communications.

As a second example, operation S102 may include: requesting the at least one other electronic device to enable the second wireless communications by the first wireless communication connection; receiving association information associated with the second wireless communications sent by the at least one other electronic device; and determining the candidate electronic device(s) based on the association information.

As an example, the association information may include, but is not limited to: information indicating that the second wireless communications has been enabled and/or second address information corresponding to the second wireless communications.

As an example, based on the association information including the second address information corresponding to the second wireless communications, the determining of the candidate electronic device(s) based on the association information may include: matching third address information of electronic device(s) that may establish the second wireless communication connection identified through the second wireless communications with the second address information in the association information; identifying electronic device(s) whose third address information matches with the second address information in the association information among the electronic device(s) that may establish the second wireless communication connection as the candidate electronic device(s).

As an example, based on the association information including the information indicating that the second wireless communications has been enabled and/or the second address information corresponding to the second wireless communications, the determining of the candidate electronic device(s) based on the association information may include: determining electronic device(s) among the at least one other electronic device that has/have sent the association information as the candidate electronic device(s). Based on the association information being received from an electronic device among the at least one other electronic device, the electronic device may be determined as the candidate electronic device.

As an example, based on the second wireless communication connection being a WLAN direct connection, the second address information may be a MAC address of the WLAN direct connection.

As an example, a request for enabling the second wireless communications and feeding back the second address information may be sent to each other electronic device by the first wireless communication connection. Accordingly, the other electronic device, based on the request, automatically enables the second wireless communications and sends its second address information and a response that the second wireless communications has been successfully enabled to the first electronic device by the first wireless communication connection.

In operation S103, identification information of the candidate electronic device(s) is displayed on an interface of the first electronic device.

As an example, based on one of the at least one other electronic device being determined as the candidate electronic device, the identification information of the electronic device may be displayed on the interface of the first electronic device.

As an example, the connection establishment method according to one or more embodiments may further include: disconnecting the first wireless communication connection with the candidate electronic device(s). For example, based on one of the at least one other electronic device being determined as the candidate electronic device, the first wireless communication connection with the electronic device may be disconnected.

As an example, the identification information of the at least one candidate electronic device may be displayed on the interface of the first electronic device in the form of a list, to facilitate the user to select a target electronic device from the candidate electronic device(s) to establish the second wireless communication connection with the first electronic device.

Further, as a third example, operation S102 may include: requesting the at least one other electronic device to enable the second wireless communications by the first wireless communication connection; and determining all the electronic device(s) that may establish the second wireless communication connection searched through the second wireless communications as the candidate electronic device(s). Accordingly, in operation S103, the identification information of electronic device(s) among the candidate electronic device(s) that belong(s) to the at least one other electronic device is displayed on the interface of the first electronic device differently from the identification information of electronic device(s) among the candidate electronic device(s) that do(es) not belong to the at least one other electronic device. For example, the identification information of the electronic device(s) among the candidate electronic device(s) that belong(s) to the at least one other electronic device may be applied to a display effect for indicating that the electronic device(s) is/are trusted electronic device(s).

With respect to the order of performing operations S101-S103, the following description is provided: operations S101-S103 may be performed sequentially with respect to each of the at least one other electronic device. In one or more embodiments, operations S101-S103 may be perform with respect to an electronic device A among the at least one other electronic device to display the identification information of the electronic device A on the interface of the first electronic device; operations S101-S103 may be performed with respect to an electronic device B among the at least one other electronic device to display the identification information of the electronic device B on the interface of the first electronic device; and so on, operations S101-S103 may be performed for each of the at least one other electronic device. In one or more embodiments, operation S101 may be performed first with respect to all of the at least one other electronic device (operation S101 may be performed with respect to all electronic devices at the same time, or operation S101 may be performed with respect to each the electronic device in turn); operation S102 may be performed with respect to all of the at least one other electronic device; and operation S103 may be performed with respect to all of the at least one other electronic device. In one or more embodiments, operations S101-S103 may be performed in parallel with respect to different electronic devices, for example, operation S101 may be performed first with respect to the electronic device A; operation S102 may be performed with respect to the electronic device A, at the same time operation S101 may be performed with respect to the electronic device B; operation S103 may be performed with respect to the electronic device A, at the same time operation S102 may be performed with respect to the electronic device B, and at the same time operation S101 may be performed with respect to an electronic device C, and so on. In addition, operations S101-S103 may also be performed in other execution sequences, for example, operation S101 may be performed with respect to all of the at least one other electronic device; and, operations S102 and S103 may be performed in parallel, with the identification information of an electronic device first being displayed on the interface of the first electronic device based on the association information sent by the electronic device being received; and without having to simultaneously display the identification information of all other electronic devices together on the interface of the first electronic device after receiving the association information sent by all other electronic devices.

In operation S104, based on a preset operation of a user on the identification information of the target electronic device(s) being detected, a second wireless communication connection is established with the target electronic device(s).

The target electronic device(s) is/are one or more of the candidate electronic device(s).

As an example, the preset operation may be an operation for selecting an electronic device, for example, it may be a user operation for selecting an electronic device for WLAN direct connection with the first electronic device.

As an example, the preset operation may include, but is not limited to, at least one of: a click operation on the identification information; a voice command for selecting the identification information.

According to one or more embodiments, the user may select another electronic device to establish a WLAN direct connection on one electronic device. The user may not operate the two electronic devices or manually enable the WLAN direct connections of the two electronic devices, which may make the user's operation more convenient, the time consumed from the selection of the connection device to the successful connection may be shorter, and the connecting operations may be fewer and more stable, which may improve the user experience.

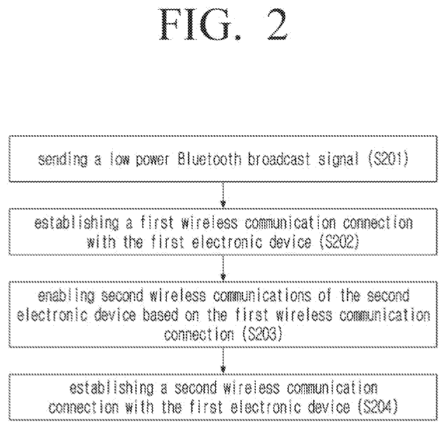

FIG. 2 illustrates a flowchart of a connection establishment method according to one or more embodiments. The connection establishment method may be applied to a second electronic device, wherein the second electronic device may be one of the target electronic device(s).

The connection establishment method may be implemented by a computer program. For example, the connection establishment method may be performed by an application installed in the second electronic device, or by a program implemented in an operating system of the second electronic device.

As an example, the second electronic device may be an electronic device such as a mobile communication terminal (for example, a smartphone), a smart wearable device (for example, a smartwatch), a personal computer, a tablet computer, a smart home device, a display, and the like.

Referring to FIG. 2, in operation S201, a low power Bluetooth broadcast signal is sent.

The low power Bluetooth broadcast signal carries first address information corresponding to a first wireless communications. In addition, the low power Bluetooth broadcast signal carries identification information of the second electronic device.

As an example, the low power Bluetooth broadcast signal may be sent periodically.

The first wireless communications is a wireless communications corresponding to the first wireless communication connection. As an examples, the first wireless communication connection may be a Bluetooth (BT) connection. As an example, the first address information may be a Bluetooth physical address (BT MAC address).

In operation S202, a first wireless communication connection is established with the first electronic device.

In operation S203, based on the first wireless communication connection, a second wireless communications of the second electronic device is enabled.

As an example, operation S203 may include: automatically enabling the second wireless communications of the second electronic device based on a second wireless communications enable request received from the first electronic device by the first wireless communication connection.

The second wireless communications is a wireless communications corresponding to the second wireless communication connection.

As an example, the second wireless communication connection may be a wireless local area network (WLAN) direct connection. As an example, based on the second wireless communication connection being a WLAN direct connection, the second address information may be a MAC address of the WLAN direct connection.

In operation S204, a second wireless communication connection is established with the first electronic device.

As an example, the second wireless communication connection may be established with the first electronic device based on a second wireless communication connection establishment request received from the first electronic device.

As an example, the connection establishment method according to one or more embodiments may further include: by the first wireless communication connection, sending association information of the second electronic device associated with the second wireless communications to the first electronic device.

As an example, the association information may include, but is not limited to: information indicating that the second electronic device has enabled the second wireless communications and/or second address information of the second electronic device corresponding to the second wireless communications.

According to one or more embodiments, the user may not operate the second electronic device to realize the establishment of the WLAN direct connection between the first electronic device and the second electronic device, which may reduce the cumbersomeness of the user's operation.

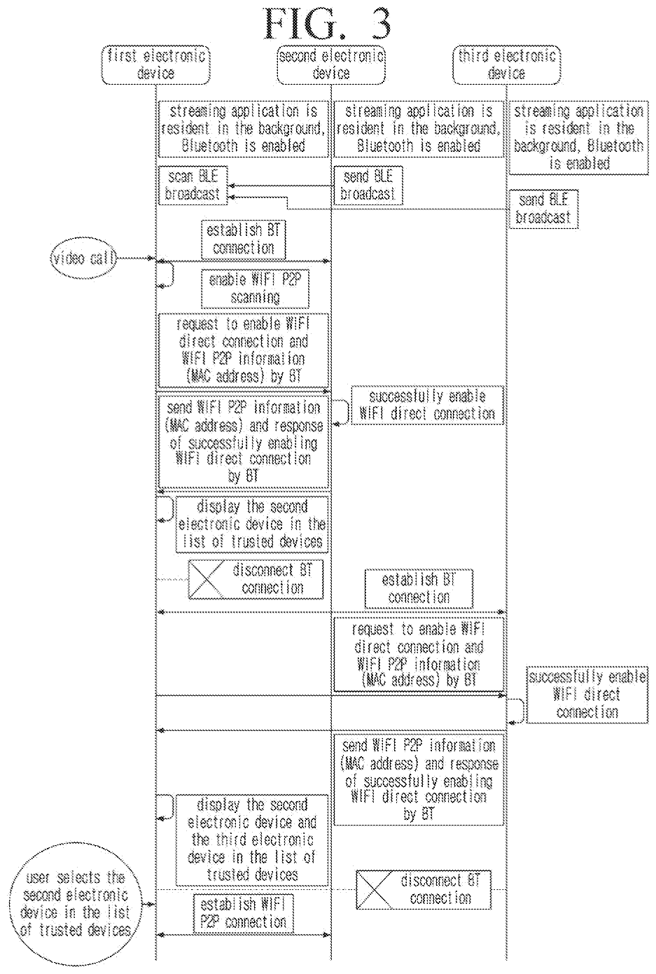

FIG. 3 illustrates an overall flowchart of a connection establishment method according to one or more embodiments.

Referring to FIG. 3, a first electronic device (host), a second electronic device (client_1), and a third electronic device (client_2) are installed with a streaming application, the streaming application is resident in the background of the first electronic device, the second electronic device, and the third electronic device, and the Bluetooth communications of the first electronic device, the second electronic device, and the third electronic device are in an enabled state.

Operation 1: The first electronic device scans nearby devices that send BLE broadcasts and obtains BT MAC addresses of trusted devices (for example, the second electronic device and the third electronic device).

The nearby devices have been sending BLE broadcasts, and the streaming application of the first electronic device scans the nearby devices that send BLE broadcasts in the background.

As an example, the streaming application of the first electronic device may be scanning in the background all the time, or it may start scanning based on detecting a video call.

Based on the first electronic device scanning the BLE broadcast and finding that the second electronic device and the third electronic device (or more devices) are trusted devices, the first electronic device obtains the BT MAC addresses contained in the BLE broadcasts of the second electronic device and the third electronic device.

Operation 2: Based on the first electronic device detecting a video call, a streaming floating window or an icon floating window of the streaming application is displayed.

As an example, based on an electronic device X initiating an invitation to a video call to the first electronic device, the first electronic device detects the invitation to the video call and the first electronic device displays the streaming floating window.

As an example, based on the first electronic device sending an invitation to a video call to the electronic device X, the first electronic device detects the invitation to the video call (for example, a message that triggers the display of the streaming floating window), and the first electronic device displays the streaming floating window.

Operation 3: Based on an operation of the user clicking on the streaming floating window, the first electronic device enables WIFI P2P communications (for example, the WLAN direct connection communications) and first establishes a BT connection with one of the trusted devices (for example, the second electronic device); the first electronic device enables the WIFI P2P communications of the second electronic device through the BT connection, and acquires a WIFI P2P MAC address of the second electronic device, and displays the second electronic device in the list of trusted connectable devices of the first electronic device and disconnects the BT connection with the second electronic device.

The first electronic device may send a request to the second electronic device by BT connection to request the second electronic device to enable the WIFI P2P communications and request the WIFI P2P MAC address of the second electronic device.

Based on enabling the WIFI P2P communications based on the request (based on the streaming application of the second electronic device receiving the request to enable the WIFI P2P communications from the first electronic device, the streaming application of the second electronic device enables the WIFI P2P communications of the second electronic device), the second electronic device replies the WIFI P2P MAC address and a response of successfully enabling the WIFI P2P to the first electronic device.

Based on receiving the reply from the second electronic device, the first electronic device displays the second electronic device in the list of trusted connectable devices and disconnects the BT connection with the second electronic device.

As an example, because the first electronic device has enabled the WIFI P2P communications to perform connectable device scanning, the first electronic device may search for devices in the surrounding area through the WIFI P2P communications; the first electronic device receives the WIFI P2P MAC address replied by the second electronic device, matches the WIFI P2P MAC address with information of the device that has been identified through the WIFI P2P communications search and displays the matched device in the list of trusted connectable devices.

For example, if the second electronic device is logged into the same user account as the first electronic device and the electronic device X is logged into another user account, the first electronic device searches for the second electronic device and the electronic device X through the WIFI P2P communications (the second electronic device has enabled the WIFI P2P communications based on a request, and the electronic device X itself has enabled the WIFI P2P communications). The first electronic device matches the received WIFI P2P MAC address replied from the second electronic device with the second electronic device and the electronic device X searched through the WIFI P2P communications, learns that the second electronic device is a trusted and connectable device, and displays the identification information of the second electronic device on the list of trusted connectable devices of the first electronic device.

As an example, if the first electronic device receives the WIFI P2P MAC address and the response of successfully enabling the WIFI P2P communications replied from the second electronic device, the first electronic device displays the identification information of the second electronic device on the list of trusted connectable devices of the first electronic device.

Other trusted devices are displayed on the list of trusted connectable devices of the first electronic device in accordance with the processing of the second electronic device. As shown in FIG. 4, the identification information of the second electronic device is displayed on the list of trusted connectable devices first, followed by the identification information of the second electronic device and the third electronic device.

It is to be understood that the first electronic device may also establish the BT connection with the second electronic device and the third electronic device at the same time; and/or, the first electronic device may send the request to enable the WIFI P2P communications to the second electronic device and the third electronic device at the same time by the BT connection.

Operation 4: The first electronic device establishes a WIFI P2P connection with a trusted device selected by the user (for example, the user selects the second electronic device).

As shown in FIG. 5, based on the user selecting a device on the list of trusted connectable devices of the first electronic device, the first electronic device may quickly establish a WIFI P2P connection with the selected device to complete the streaming.

According to one or more embodiments, a method of quickly establishing interconnection with a trusted device is provided, because during the period from the time when the user clicks on the streaming floating window to the display of the list of trusted connectable devices, the first electronic device has already sequentially established the BT connection with the nearby trusted devices, has successfully acquired the WIFI P2P MAC address of each trusted device by the BT connection, and has confirmed that each trusted device is in the WIFI P2P searchable state. Based on displaying the list of trusted connectable devices, there may be one operation of WIFI P2P connection left during the process from the user selecting the device to connecting it successfully, which may improve the connection speed and stability of the process.

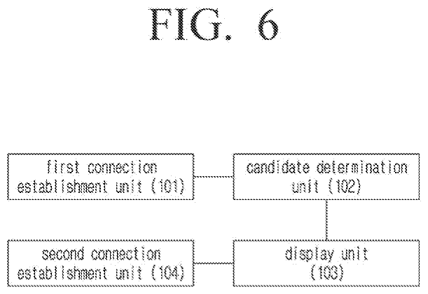

FIG. 6 illustrates an architecture diagram of a connection establishment apparatus according to one or more embodiments. The connection establishment apparatus is applied to a first electronic device.

The connection establishment apparatus according to one or more embodiments: a first connection establishment unit 101, a candidate determination unit 102, a display unit 103, a second connection establishment unit 104.

The first connection establishment unit 101 may be configured to establish a first wireless communication connection with at least one other electronic device searched.

The candidate determination unit 102 may be configured to determine candidate electronic device(s) from the at least one other electronic device based on the first wireless communication connection.

The display unit 103 may be configured to display identification information of the candidate electronic device(s) on an interface of the first electronic device.

The second connection establishment unit 104 may be configured to establish a second wireless communication connection with target electronic device(s) based on a preset operation of a user on the identification information of the target electronic device(s) being detected.

The target electronic device(s) is/are one or more of the candidate electronic device(s).

As an example, the candidate determination unit 102 may be configured to request the at least one other electronic device to enable a second wireless communications by the first wireless communication connection; receive association information associated with the second wireless communications sent by the at least one other electronic device; and determine the candidate electronic device(s) based on the association information; wherein the second wireless communications is a wireless communications corresponding to the second wireless communication connection.

As an example, the association information may include: second address information corresponding to the second wireless communications; wherein the candidate determination unit 102 may be configured to match the second address information of electronic device(s) that may establish the second wireless communication connection searched through the second wireless communications with the second address information in the association information; determining electronic device(s) whose second address information matches with the second address information in the association information among the electronic device(s) that may establish the second wireless communication connection as the candidate electronic device(s).

As an example, the association information may include: information indicating that the second wireless communications has been enabled and second address information corresponding to the second wireless communications; wherein the candidate determination unit 102 may be configured to determine electronic device(s) among the at least one other electronic device that has/have sent the association information as the candidate electronic device(s).

As an example, the first connection establishment unit 101 may be configured to establish the first wireless communication connection with the at least one other electronic device searched and automatically enable a second wireless communications of the first electronic device based on an event being detected; wherein the event includes at least one of: receiving a user operation triggering the opening of an application, receiving a user operation triggering the display of a connection object setting interface for the second wireless communication connection, wherein the application is an application for transmitting content across devices; wherein the second wireless communications is a wireless communications corresponding to the second wireless communication connection.

As an example, the first connection establishment unit 101 may be further configured to: based on the determining of the candidate electronic device(s) from the at least one other electronic device based on the first wireless communication connection, disconnect the first wireless communication connection with the candidate electronic device(s).

As an example, the at least one other electronic device may be an electronic device that sends a low power Bluetooth broadcast signal in the vicinity of the first electronic device.

As an example, the first wireless communication connection may be a Bluetooth connection.

As an example, the second wireless communication connection may be a WLAN direct connection.

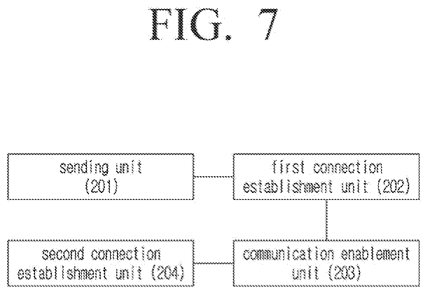

FIG. 7 illustrates an architecture diagram of a connection establishment apparatus according to one or more embodiments. The connection establishment apparatus may be applied to a second electronic device. The second electronic device may be one of the target electronic device(s).

The connection establishment apparatus according to one or more embodiments include: a sending unit 201, a first connection establishment unit 202, a communication enablement unit 203, a second connection establishment unit 204.

The sending unit 201 may be configured to send a low power Bluetooth broadcast signal, wherein the low power Bluetooth broadcast signal carries first address information corresponding to a first wireless communications.

The first connection establishment unit 202 may be configured to establish a first wireless communication connection with the first electronic device, wherein the first wireless communications is a wireless communications corresponding to the first wireless communication connection.

The communication enablement unit 203 may be configured to enable a second wireless communications of the second electronic device based on the first wireless communication connection.

The second connection establishment unit 204 may be configured to establish a second wireless communication connection with the first electronic device.

The second wireless communications is a wireless communications corresponding to the second wireless communication connection.

As an example, the communication enablement unit 203 may be configured to automatically enable the second wireless communications of the second electronic device based on a second wireless communications enable request received from the first electronic device by the first wireless communication connection.

As an example, the communication enablement unit 203 may be further configured to send association information of the second electronic device associated with the second wireless communications to the first electronic device by the first wireless communication connection based on the enabling of the second wireless communications of the second electronic device based on the first wireless communication connection.

As an example, the association information may include: information indicating that the second electronic device has enabled the second wireless communications and/or second address information of the second electronic device corresponding to the second wireless communications.

As an example, the first wireless communication connection may be a Bluetooth connection.

As an example, the second wireless communication connection may be a WLAN direct connection.

It is to be understood that the individual units in the connection establishment apparatus according to one or more embodiments may be implemented as hardware components and/or software components. A person skilled in the art may, for example, use a field programmable gate array (FPGA) or an application specific integrated circuit (ASIC) to implement the individual units, depending on the processing performed by the individual units as defined.

A computer readable storage medium according to one or more embodiments stores a computer program that, when executed by a processor, causes the processor to perform a connection establishment method according to one or more embodiments. The computer readable storage medium may be a data storage apparatus that may store data read by a computer system. Examples of the computer readable storage media may include: a read-only memory, a random access memory, a read only CD-ROM, a magnetic tape, a floppy disk, an optical data storage apparatus, and a carrier wave (such as data transmission over an Internet via a wired or wireless transmission path).

The electronic device according to the one or more embodiments includes: a processor and a memory, wherein the memory stores a computer program that, when executed by the processor, implements a connection establishment method as described in the above one or more embodiments.

Although one or more embodiments have been represented and described, it is to be understood by those skilled in the art that one or more embodiments may be modified without departing from the principles and spirit of the present disclosure as limited in scope by the claims and their equivalents.

What is claimed is:

1. A connection establishment method, applied to a first electronic device, comprising:
establishing a first wireless communication connection with at least one other electronic device identified based on a first search;
determining at least one candidate electronic device from the at least one other electronic device based on the first wireless communication connection;
displaying first identification information of the at least one candidate electronic device on an interface of the first electronic device; and
establishing a second wireless communication connection with at least one target electronic device based on detecting a preset operation of a user and second identification information of the at least one target electronic device,
wherein the at least one target electronic device includes one or more of the at least one candidate electronic device.

2. The connection establishment method according to claim 1, wherein the determining the at least one candidate electronic device from the at least one other electronic device based on the first wireless communication connection comprises:
requesting the at least one other electronic device to enable second wireless communications by the first wireless communication connection;
receiving association information sent by the at least one other electronic device associated with the second wireless communications; and
determining the at least one candidate electronic device based on the association information, and
wherein the second wireless communications correspond to the second wireless communication connection.

3. The connection establishment method according to claim 2, wherein the association information comprises second address information corresponding to the second wireless communications, and
wherein the determining the at least one candidate electronic device based on the association information comprises:
matching third address information of at least one third electronic device identified through the second wireless communications with the second address information; and
determining at least one of the at least one third electronic device whose third address information matches the second address information as the at least one candidate electronic device.

4. The connection establishment method according to claim 2, wherein the association information comprises information indicating the second wireless communications have been enabled and second address information corresponding to the second wireless communications, and
wherein the determining the at least one candidate electronic device based on the association information comprises determining at least one of the at least one other electronic device that has sent the association information as the at least one candidate electronic device.

5. The connection establishment method according to claim 1, wherein the establishing the first wireless communication connection further comprises automatically enabling second wireless communications of the first electronic device based on an event being detected,
wherein the event comprises at least one of: receiving a first user operation triggering an opening of an application, or receiving a second user operation triggering a display of a connection object setting interface for the second wireless communication connection,
wherein the application supports transmitting content across devices, and
wherein the second wireless communications correspond to the second wireless communication connection.

6. The connection establishment method according to claim 1, wherein based on the determining the at least one candidate electronic device, the method further comprises disconnecting the first wireless communication connection from the at least one candidate electronic device.

7. The connection establishment method according to claim 1, wherein the at least one other electronic device sends a low power Bluetooth broadcast signal in a vicinity of the first electronic device.

8. The connection establishment method according to claim 1, wherein the first wireless communication connection is a Bluetooth connection.

9. The connection establishment method according to claim 1, wherein the second wireless communication connection is a WLAN direct connection.

10. A connection establishment method, applied to a second electronic device, comprising:
sending a low power Bluetooth broadcast signal carrying first address information corresponding to first wireless communications;
establishing a first wireless communication connection with a first electronic device corresponding to the first wireless communication connection;
enabling second wireless communications of the second electronic device based on the first wireless communication connection; and
establishing a second wireless communication connection with the first electronic device,
wherein the second wireless communications correspond to the second wireless communication connection.

11. The connection establishment method according to claim 10, wherein the enabling the second wireless communications comprises automatically enabling the second wireless communications of the second electronic device based on a second wireless communications enable request received from the first electronic device by the first wireless communication connection.

12. The connection establishment method according to claim 10, wherein based on the enabling of the second wireless communications of the second electronic device, the connection establishment method further comprises sending association information of the second electronic device associated with the second wireless communications to the first electronic device by the first wireless communication connection.

13. The connection establishment method according to claim 12, wherein the association information comprises at least one of: first information indicating that the second electronic device has enabled the second wireless communications or second address information of the second electronic device corresponding to the second wireless communications.

14. The connection establishment method according to claim 10, wherein the first wireless communication connection is a Bluetooth connection.

15. A connection establishment apparatus, applied to a first electronic device, comprising:
one or more processors; and
a memory storing at least one instruction that, when executed by at least one of the one or more processors, causes the apparatus to:
establish a first wireless communication connection with at least one other electronic device identified based on a search;
determine at least one candidate electronic device from the at least one other electronic device based on the first wireless communication connection;
display first identification information of the at least one candidate electronic device on an interface of the first electronic device; and
establish a second wireless communication connection with at least one target electronic device based on a detected preset operation of a user and second identification information of the at least one target electronic device,
wherein the at least one target electronic device comprises one or more of the at least one candidate electronic device.

16. The connection establishment apparatus according to claim 15, wherein the apparatus is configured to determine the at least one candidate electronic device by executing the at least one instruction to cause the apparatus to:
request the at least one other electronic device to enable second wireless communications by the first wireless communication connection;
receive association information sent by the at least one other electronic device by the second wireless communications; and
determine the at least one candidate electronic device based on the association information, and
wherein the second wireless communications correspond to the second wireless communication connection.

17. The connection establishment apparatus according to claim 16, wherein the association information comprises second address information corresponding to the second wireless communications, and
wherein the apparatus is configured to determine the at least one candidate electronic device based on the association information by executing the at least one instruction to cause the apparatus to:
match third address information of at least one third electronic device identified through the second wireless communications with the second address information; and
determine at least one of the at least one third electronic device whose third address information matches the second address information as the at least one candidate electronic device.

18. The connection establishment apparatus according to claim 16, wherein the association information comprises:
information indicating the second wireless communications have been enabled; and
second address information corresponding to the second wireless communications, and
wherein the apparatus is configured to determine the at least one candidate electronic device based on the association information by executing the at least one instruction to cause the apparatus to determine at least one of the at least one other electronic device that has sent the association information as the at least one candidate electronic device.

19. The connection establishment apparatus according to claim 15, wherein the apparatus is further configured to establish the first wireless communication connection by executing the at least one instruction to cause the apparatus to automatically enable second wireless communications of the first electronic device based on an event being detected,
wherein the event comprises at least one of:
a first user operation triggering an opening of an application being received; or
a second user operation triggering a display of a connection object setting interface for the second wireless communication connection being received,
wherein the application is configured to transmit content across devices, and
wherein the second wireless communications correspond to the second wireless communication connection.

20. The connection establishment apparatus according to claim 15, wherein the apparatus is further configured to execute the at least one instruction to cause the apparatus to disconnect the first wireless communication connection from the at least one candidate electronic device based on the at least one candidate electronic device being determined.
